(19) United States
(12) Patent Application Publication
(10) Pub. No.: US 2024/0168193 A1
(43) Pub. Date: May 23, 2024

(54) SYSTEM FOR DETECTING THE PATH OF MOVING OBJECTS

(71) Applicant: Share My Space, Cergy Pontoise Cedex (FR)

(72) Inventors: Damien Giolito, Paris (FR); Romain Lucken, Paris (FR)

(21) Appl. No.: 18/551,047

(22) PCT Filed: Mar. 17, 2022
(86) PCT No.: PCT/FR2022/050492

§ 371 Date: Sep. 18, 2023

(30) Foreign Application Priority Data
Mar. 17, 2021 (FR) FR2102684

(51) Int. Cl. G01V 8/00; B64G 3/00; G06T 7/20

(52) U.S. Cl. CPC G01V 8/00; B64G 3/00; G06T 7/20; G06T 2207/30241

(57) ABSTRACT

A system for detecting the path of moving objects, comprises telescopes rotating in an azimuthal plane and each oriented with an elevation angle between 30° and 85°, each of the telescopes having a field of view between 2 and 6 degrees square and comprising a sensor of N×M pixels each of a width L. The system comprises a computer for storing time-stamped images delivered by the sensor of each of the telescopes and for computing the path of a celestial object depending on luminous traces of the celestial object in a first image and in a second image.

### CROSS-REFERENCE TO RELATED APPLICATIONS

This application is a national phase entry under 35 U.S.C. § 371 of International Patent Application PCT/FR2022/050492, filed Mar. 17, 2022, designating the United States of America and published as International Patent Publication WO 2022/195231 A1 on Sep. 22, 2022, which claims the benefit under Article 8 of the Patent Cooperation Treaty of French Patent Application Serial No. FR2102684, filed Mar. 17, 2021.

### TECHNICAL FIELD

The present disclosure relates to the detection of objects present in space at low and high altitudes by way of an array of telescopes. More particularly, the present disclosure relates to the detection of satellites and space debris as well as aircraft or any moving object illuminated by the sun and the observation system at night, and to the calculation of the orbit and paths thereof in order to prevent them from falling to Earth, colliding in space, or entering a hazardous zone.

### BACKGROUND

The detection of orbital debris is very problematic. In fact, following an object whose size can be less than ten centimeters, to several thousand kilometers of distance is an arduous task.

Furthermore, as the objects have paths that are very different from one another, it is very difficult for economic reasons to cover the entire sky with the appropriate detection capabilities.

The ESA (European Space Agency) has estimated the number of space objects such as active and inactive satellites, bodies discarded when launching satellites, such as rocket nose-cones, for example, rocket bodies, and small fragments to be:
5,400 space debris larger than one meter;
34,000 space debris larger than 10 centimeters;
900,000 space debris larger than one centimeter;
130,000,000 space debris larger than one millimeter.

Currently, monitoring near space and, in particular, objects presenting a potential danger, whether natural or artificial, has become a major problem in ensuring the safety and integrity of any target that could be subjected to a collision.

This monitoring relates both to active satellites and to those that are at the end of life or uncontrolled, and to debris coming from previous collisions, from wear on objects in orbit or asteroids or comets that present a potential danger to the Earth.

Space agencies and private operators have developed various monitoring programs grouped under the name “Space Situational Awareness.”

Even in the case where a meteorite is of relatively small size, the risks induced by a fall remain high. There is therefore a danger to people and infrastructure on the surface of the Earth from any falling moving object whose the fragmentation in the atmosphere may cause significant damage. One of the problems encountered is the counting of small bodies of the solar system whose orbit intersects that of the Earth and tracking them in order to evaluate their dangerousness.

Artificial objects are found more and more in low or high orbits. Space seems to become more crowded every year, due to the presence of increasingly numerous satellites, and to the proliferation of catastrophic collisions resulting in an increase in the number of debris. Failure to track their path, or to do so adequately, remains an increasing problem.

Projections are forecasting a situation in which an increase in the population of debris of size greater than 1 cm will make it harder to control and monitor such debris. The threshold of 1 cm corresponds to the size of an object that could potentially render a satellite wholly or partially inoperative, due to the speeds involved: 3 km/s in geostationary orbit up to 8 km/s in low Earth orbit.

These objects are referred to herein as “space objects,” with the understanding that space objects include actual debris, satellites (whether operational or not), and even meteorites.

A first problem concerns the fall of debris toward the surface of the Earth and a second problem concerns the collision of debris, either between them or with active satellites. Monitoring the debris in space, and more particularly in low orbits, makes it possible to prevent these two consequences.

Finally, the problem of monitoring different moving objects in space also relates, by extension, to monitoring discrete moving objects traveling at very low altitude such as aircraft, for example, ultralight aircraft or drones, which can pose a hazard, for example, when their flight path approaches a sensitive site. One difficulty is to find a wide-field optical system that makes it possible to cover a significant portion of the sky with high enough resolution to detect objects at different altitudes, both distant and close, and to follow objects at low altitudes moving at high speeds, which makes them difficult to detect.

Indeed, one problem of the detection and monitoring of space debris, whose orbit and/or path is not known, is the consideration of the intensity of light from third-party sources, which disturbs the detections.

These sources may originate from the sky, the sun, the moon and the local weather conditions that alter the stability of the exposure conditions. The monitoring system must be able to take into account a multitude of luminosity conditions making it possible to maximize detections in all circumstances. As the detection takes place by considering a point or an area on the surface of the globe, the condition of the field of view of the observation system is an extremely important piece of data in calculating the probability of detecting of a moving object and in calculating its path.

The problem of debris monitoring concerns various orbits to be taken into account in the methods for detecting moving objects in space. As regards natural objects such as meteorites, their orbit is generally heliocentric, which means that the meteorites can potentially approach the Earth at any altitude and from any direction. As regards artificial objects, their Earth orbit can be classified into different families of orbits.

The first family of orbits is known under the acronym LEO, for “Low Earth Orbit.” This is a family of low orbits ranging up to 2000 km. This family of orbits is commonly used by satellites for communications, military, detection, weather, etc.

A second family of orbits is known by the acronym GEO, for “geostationary orbit,” which is defined as being 35784 km above the equator. One revolution of a moving object at this altitude is 24 h. The moving object being located in a geostationary orbit is fixed relative to a terrestrial position. However, debris can leave their orbit and have non-geostationary orbits. This orbit is commonly used by satellites for communication (military or civilian), remote detection, weather, etc.

A third family of orbits is better known by the acronym MEO, designating “medium Earth orbit,” which is a family of medium-level orbits, generally, elliptical. This family includes GNSS satellites.

A fourth family of orbits is designated by the acronym HEO, for “highly elliptical orbits,” including very elliptical orbits such as, for example, Molniya or Tundra orbits, which make it possible to communicate or monitor the regions of high latitudes.

A fifth family of orbits is designated by the acronym GTO, for “geostationary transfer orbit.” This family comprises elliptical orbits. Their apogee is on the order of 42,000 km and their perigee is on the order of 650 km. This family of orbits is very practical for injecting satellites into geostationary orbit; it is therefore used during satellite launch operations as a transitional orbit for a geostationary orbit setting.

Today different methods exist for detecting space debris and their path.

In particular, there is a family of methods called “active methods,” especially for detecting debris in LEOs (low Earth orbits). The active methods rely on radar-type functioning wherein a moving object is illuminated by a source emitting a signal. The signal is then reflected and it is the reflection of the signal that informs a receiver of position data of the moving object.

A first drawback of this method is that the received power varies as 1/d4, where “d” is the distance from the moving object to the transmitter/receiver. Consequently, the received power will remain low during detection, even if a high transmission power is employed.

A second drawback is the relatively large installation of a radar system that this method requires. These installations are expensive and require considerable maintenance and are easily detectable. Furthermore, these systems consume a lot of energy and must consequently be installed near an electrical grid.

Active methods also include LIDARs, which rely on an illumination of a moving object by a laser. This method makes it possible to achieve better results than those of radar in terms of detected power since the laser light is better focused. On the other hand, the detection cones are much smaller and are not very suitable for “blind” detections of moving objects in low and elliptical orbits. Another family of methods exists: these are passive methods. Applied to radar, these methods relate to receiving installations only. They must therefore be placed close to a powerful radar transmission source. Detection technologies for which targets are not illuminated by an Earth-based source are also considered to be passive. As regards passive methods, the light flux captured by a detector varies with the distance “d” to the moving object according to 1/d2, which offers better results than active methods on the captured light flux coming from the moving object. On the other hand, the major drawback is the heavy dependence on illumination from external sources such as the sun, the stars or the moon. The advantage of these solutions lies in their low costs and in the relative simplicity of their implementation from detectors based on optical instruments capable of viewing small objects at all altitudes.

As regards moving objects in geostationary orbit, a telescope or a radar or any other electromagnetic detection device may detect an immobile point against a backdrop of moving stars during the time of installation. With a wide-field telescope, it is then possible to detect moving objects in space on a geostationary belt as well as their path.

In the case of the other orbits, called “polar” and therefore non-geostationary, that is to say not fixed with respect to an observation point on Earth, it is difficult to detect moving objects in space, their height, their inclination, and their orbital nodes, including the ascending and descending nodes.

One difficulty comes from the orbital speed of the moving objects in space, which may exceed 1°/s at the zenith for a low orbit. Detection is done by capturing a trace corresponding to a moving object (on a sequence of images) vis-à-vis point traces or trails as a function of sidereal movement and therefore of the observation window in the sky.

The method then involves distinguishing the traces, in order to detect the presence of a space debris. Although inclination can possibly be detected depending on the analysis of the trace left by the moving object, it nonetheless remains very difficult to obtain the actual altitude of the moving object due to its distance not being known. However, it can be estimated by virtue of the speed of the moving object. Consequently, it is difficult to deduce elements from the path of the moving object by extrapolating the analyses of the traces. In the general case, it is necessary to have three angular position measurements of the moving object to derive its orbit. Two measurements are sufficient if the moving object is in a circular orbit.

The problem can be solved by increasing the field of a telescope in order to increase the traces and their number, but the images detected, as explained previously, can become difficult to analyze due to the number, the complexity of the telescopes to be implemented, surrounding light pollution, substantial confusion caused by all of the objects in the field, and the very large size of the sensors required.

Furthermore, the construction of a wide-field telescope is hardly conceivable beyond a few degrees, unlike photographic lenses.

Indeed, a wide-field optic makes it possible to deduce information regarding the path of the moving object; however, a wide field is more likely to be affected by parasitic light sources. Furthermore, it remains very difficult to design wide-field telescopes without encountering design problems, with particularly complex optical circuitry and huge construction costs. The presence of a wide focal plane also leads to numerous aberrations. When an electronic detector is coupled to a wide-field optic, it must be of very large size; the sizes and the number of pixels may be very high, the design and manufacture costs are substantial, and operation is difficult.

There are telescope systems that make it possible to obtain a very large field by coupling an array of large-field telescopes to form a single field.

French Patent No. FR3018612 [WO2015136102] describes another known solution for detecting a moving object in space, characterized in that it comprises:
generating a plurality of fields of view (Zkp) by way of a first set of telescopes (T), each telescope defining a detection telescope, the set of fields (FOV) of each telescope (Ty) having a spatial distribution in at least one plane of the space inscribed in an open geometric shape (CC), the open geometric shape (CC) defining a wide detection field;
detecting at least one trace of a moving object (M-i) in the field (FOVy) of at least one telescope (Ty) by an electronic detector coupled to each telescope (Ty), the integration time of the electronic detector being defined in order to obtain a spread of the trace across several pixels of the electronic detector for a given maximum orbital speed (VM) of a moving object and a minimum altitude of its orbit;
deducting a path (TJSAT) of the moving object (M-i) in the image plane of the telescope (Ty).

The company ASTRIUM proposes another solution, which is described in U.S. Patent Application Publication No. US2013/264463. This document describes an optical system for a space monitoring system, which is characterized in that it comprises an array of N×P telescopes, each with a field greater than or equal to 5° and preferably greater than or equal to 10°, the telescopes being coupled to N×P image sensors whose sensitivity is suitable for an integration time on the order of magnitude of 10 to 100 milliseconds, the telescopes being mounted on one or more motorized mounts, the telescopes being slaved together and grouped together so as to operate simultaneously in order to afford a wide field, and in that the speed of movement of the telescope mounts is such that each object passing through the scanned zone is detected at least three times so as to obtain at least three dated position measurements distributed across the transit arc of the object in the sky, the exposure time or integration time being defined in order to obtain a spread of the signal over multiple pixels.

One drawback of this solution is the cost of such a system, which requires numerous telescopes with a very wide field (several thousand). One solution is to reduce the number of telescopes and to associate a motorized tracking system with wider-field telescopes having at least one field of 5°, and in practice 14° in the example cited in the document (10°×10° on the square detector).

U.S. Pat. No. 7,105,791 describes a system that makes it possible to use an image of the Sun to detect objects traveling through the Earth's atmosphere. The system comprises a receiver for collecting incident sunlight (solar energy) and a light-sensitive device that produces a signal in response to exposure to light. A signal processor is coupled to the photosensitive device, the signal processor detecting the incident sunlight collected and being programmed to deliver a corresponding output signal in order to provide a detection signal in response to a shadow that moves through the photosensitive device.

European Patent No. EP1167997B1 proposes another solution for measuring space pollution, intended to be installed on board a satellite, comprising: at least one laser illuminator that can emit a laser beam into space; means for receiving the signal retroreflected by space debris, means for detecting space debris that passes through the laser beam, determining the angular position of the debris, means for localizing the detected debris, determining the distances of the detected debris relative to the satellite using the pulsed and/or modulated nature of the emission of the laser beam; means for classifying the localized debris, determining, for each item of debris localized, the product of its average albedo on its apparent surface.

The solutions of the prior art require expensive equipment to ensure significant coverage of the celestial sphere (several tens of degrees), with telescopes that have large fields of view or with a large number of ground-based or satellite-based telescopes covering a large field.

### BRIEF SUMMARY

In order to address these drawbacks, it is essential to catalog all potentially dangerous debris and to associate it with valid orbital parameters that allow their paths to be described. Observed from a fixed point on the Earth, the objects in low orbit are characterized in that they move rapidly across the sky. Furthermore, at each instant a plurality of objects pass through the sky in a plurality of places. According to its orbital parameters each object passes through the local sky at more or less regular time intervals, ranging from a few tens of minutes to several hours.

To that end, the present disclosure relates, in its broadest sense, to a system for detecting the path of moving objects, characterized in that it comprises a platform rotating in an azimuthal plane supporting a plurality of telescopes that are each oriented with an elevation angle between 35° and 85°, each of the telescopes having a field of view of between 2 and 6 degrees square and comprising a sensor of N×M pixels each having a width L. The system further comprises a computer for storing time-stamped images delivered by the sensor of each of the telescopes and for computing the path of a celestial object depending on luminous traces of the celestial object in a first image I1 and in a second image I2.

Advantageously, the platform rotates in a jumping manner.

Preferably, the platform supports either four telescopes each separated by 90°, or six telescopes separated by 60°, or eight telescopes separated by 45°.

According to one particular embodiment, the telescopes rotate step by step with a rotation of multiple degrees per second, depending on the angle between the telescopes, the field of view of the telescopes and their elevation angle relative to the horizon.

### BRIEF DESCRIPTION OF THE DRAWINGS

The present disclosure will be better understood on reading the following description, which concerns a non-limiting exemplary embodiment illustrated in the accompanying drawings, in which:

FIG. 1 schematically shows a perspective view of a rotating platform according to the present disclosure;

FIG. 2 schematically shows a sectional view of a rotating platform according to the present disclosure;

FIG. 3 schematically shows two image captures;

FIG. 4 schematically shows kinematics of the platform bearing the rotating telescopes relative to the platform;

FIG. 5 schematically shows a movement cycle of a telescope;

FIG. 6 schematically shows a schematic view of the geographical locations of all of the telescopes;

FIG. 7 schematically shows a predicted collision and the highlighting, using ellipsoids, of positional uncertainties, allowing probabilities of collision to be established;

FIG. 8 shows the functional architecture for image processing;

FIG. 9 shows the functional architecture of processing block 1 for the local preprocessing of data;

FIG. 10 shows the functional architecture of processing block 2 for the classification of objects; and

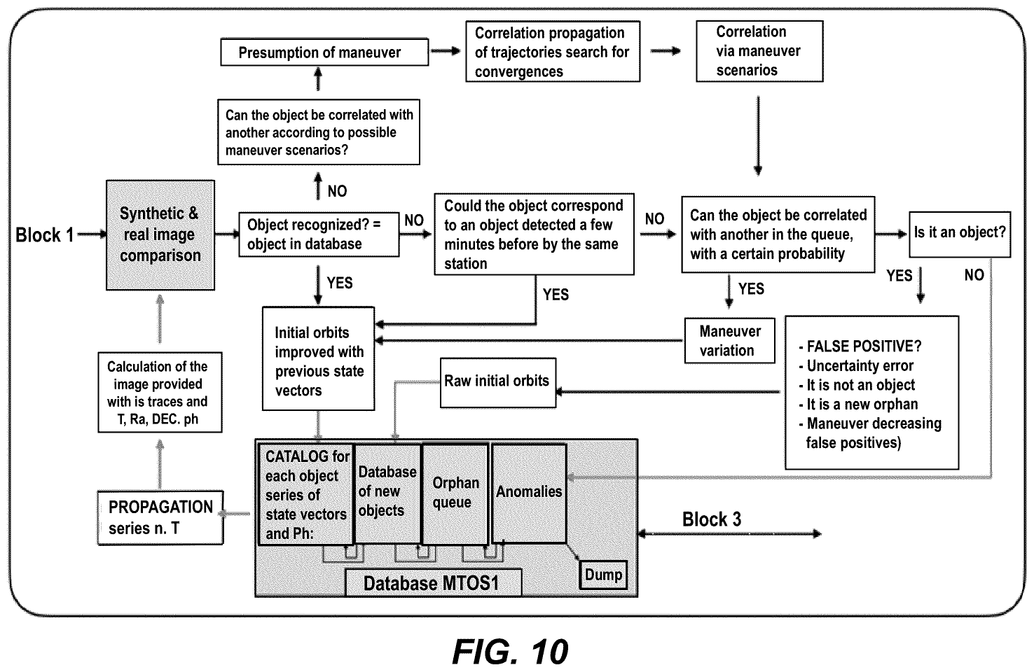

FIG. 11 shows the functional architecture of blocks 4 to 7.

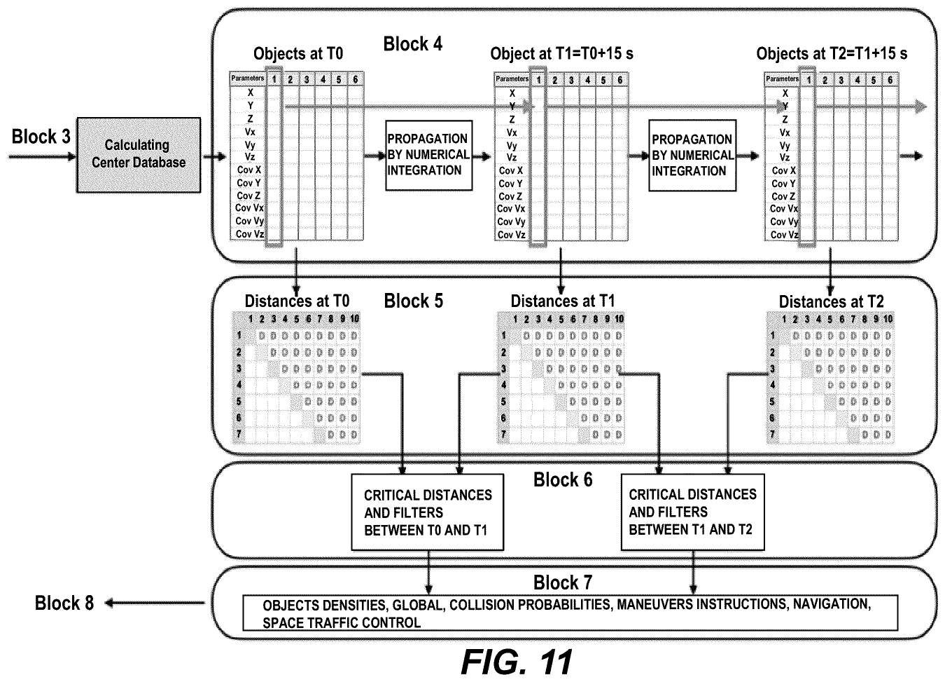

### DETAILED DESCRIPTION

Principle of the Present Disclosure

The object of the present disclosure is to provide a means for the optical detection of celestial objects within a very open solid angle of about 1 steradian (between 30 and 120 degrees in a plane), with sufficient resolution to detect an object of a few centimeters in cross section from low Earth orbits, up to geostationary orbits. (This comment is to counter arguments that the optics cannot be used in low Earth orbit due to satellite speed). No observation installation currently has optical characteristics that allow such specifications to be met and only an array of a large number of telescopes would allow this level of performance to be achieved, but this would be prohibitively expensive.

The present disclosure is based on:
a first postulate that a celestial object will necessarily pass through an annular ring centered around an axis, with this potentially being zenithal, polar or as chosen.
a second postulate that it is possible to cover such an annular ring with an array of N telescopes of limited field of view 360/N,
and a third postulate that it is possible to emulate such an array with a smaller number of telescopes that are rotated at a sufficient speed for the object to be viewed during its movement at least three times.

The system according to the present disclosure makes the following possible:
detection of small objects, in large quantities, in low Earth orbit, which are too fast for conventional optical methods, contrary to the use of radar technology in general;
detection can be carried out using traces left by the object in the images (watching/passive mode rather than “tracking”), time-stamping both ends of the straight line (time-stamped open and close), and determining a length of the trace;
determination of an initial path by way of astrometry reduction and using exposure dating (submillisecond), the accuracy of which increases over the course of the observations; and
all of the reconstructed paths allow an object catalog to be created and maintained over time.

The technical advantage resulting from the present disclosure is that of making it possible to limit the number of stations worldwide, with a large field (3° to 6°) and a limited number of telescopes per station, while maintaining very high detection sensitivity for capturing small objects and the ability to create and maintain an object catalog in all orbits, and particularly low Earth orbit.

Main Features of the Present Disclosure

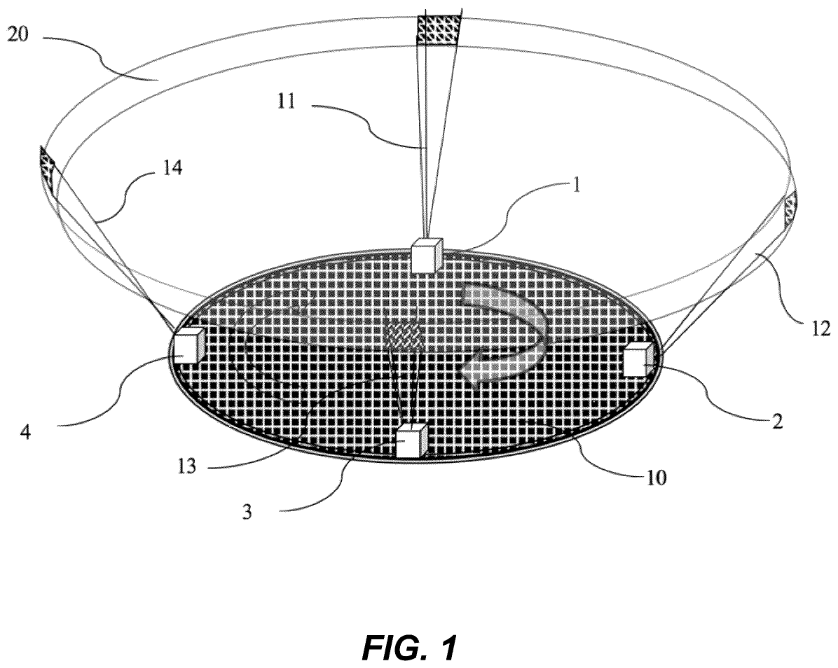

The system is based on the watching observation of an observation ring 20 at a certain elevation angle, in order to capture all of the objects that pass through this ring 20 (FIG. 1). (Unlike the observation of a segment of sky). The system makes use of the time taken for an object to pass across the field of the telescope (at the time of image capture) to rotate the telescopes along a vertical axis (pointing toward the zenith) without missing the detection of objects.

In the case of four observation stations (each comprising four telescopes) and for an object transit time in a field of 5°, the stations are not all located at the same latitude in order to compensate for the seasons and make it possible to capture objects at all latitudes. They are also distributed longitude-wise, so as always to have observation at night.

An object at 400 km at a relative average speed of 0.5°/s takes 10 s to traverse a field of 5°. Over these 10 s, the N+1 camera must be replaced with the camera N before the object exits the field.

The following variables and parameters are defined:
V: speed of rotation of the object relative to the position of the observation system at a given altitude and elevation angle;
C: vertical and horizontal field of the camera;
N: number of telescopes;
T: time taken by the object to cross the field C;
P: number of steps taken to rotate by C horizontal degrees per second; and
E: object elevation angle relative to the horizontal plane at the foot of the observation system.

The relationships between these variables are as follows:

T×V=C

P×C=360. Cos E/N/T in this example. P×5°=360/4/10=>P=1.5 steps per second.

The total number of steps with N telescopes is:
for E=0°=>Ptot=360/C;
E=40°=>Ptot=360×cos 40/C

where P=Ptot/C/T.

The choice of elevation angle is a trade-off:
The lower the object on the horizon, the slower its relative speed of rotation, but the farther away the object will be; the closer the object to zenith, the closer it will be but the faster its speed of rotation.
The exposure time for each image is related to the instantaneous speed of the object according to its altitude. This is the time taken for the object to pass through a pixel, multiplied by at least 50, so that the traces need at least 50 pixels for them to be correctly detected automatically.

For this reason, the speed of rotation of the telescope is slaved to the elevation angle: the lower it is, the slower the object. The closer it is to zenith, the faster it is.

Alternative Implementing Rotating Platforms

These postulates lead to a solution that includes a platform supporting multiple rotating telescopes, four in the example described by way of non-limiting example, for a space situational awareness (“SSA”) application, for the monitoring of objects close to the Earth, for detecting natural objects, such as asteroids and comets, which might strike the Earth, and for the monitoring of space, for the tracking of active and inactive artificial satellites and space debris and for estimating paths and risks of collision. The objective of the present disclosure is the optimization of the number of telescopes required for surveillance activities in order to perform overall monitoring of the objects in orbit for a fraction of the cost of current installations.

Proceeding in this manner makes it possible to compensate for the limited number of telescopes with respect to the preceding solution, by virtue of a scan achieved through the synchronized rotation of the optical measurement devices each pointing in opposite directions of angle 360°/N telescopes.

The observation ring detection system makes it possible to detect each object at two locations that are very far apart in the sky, which, combined with the double measurement as the object passes through the field of the ring, results in a very high number and quality of observed positions. These four positions in space and over time allow a very good immediate approximation of the path of the object to be made.

This means that the computer system has to be able to recognize that the object measured a first time in the observation ring 20 is indeed the same as that measured at such a position a second time in the observation ring 20. The two measurements taken during the first ring transit allow a prediction to be made for the second ring transit. The algorithm should therefore check traces detected close to the predicted position and time in order to establish matches with an optimal degree of confidence.

Practical Description of the Platform

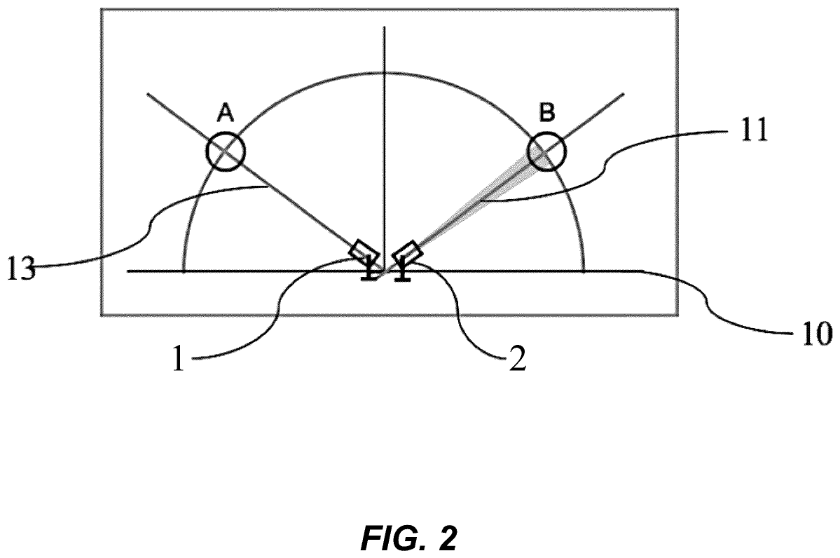

FIGS. 1 and 2 schematically show a platform (10) according to the present disclosure. This platform (10), placed in an azimuthal plane, bears four telescopes (1 to 4) separated by 90°. Each telescope is rotated relative to a zenithal axis in a jumping motion, which will be described in detail below.

The platform (10) bearing the cameras (1 to 4) is fixed in location. Optionally, it can be constantly rotated, preferably in a jumping manner, in such a way that it is synchronized with the rotation of the cameras (1 to 4).

Alternatively, the telescopes can be rotated with a constant movement, the connection between each telescope (1 to 4) and the platform (10) being provided by a mechanism that oscillates in a tangential direction about a median position.

The elevation angle of the telescopes is 66° and their field angle is 4 degrees square. Each telescope comprises a sensor with N-M pixels.

Space objects are detected as streaks in the astrophotography images, which are processed for RA-DEC conversion and orbit determination. The ability to detect space objects depends on the time taken for the object to pass through a pixel, particularly in the case of objects in low Earth orbit at an altitude on the order of 2000 km, where the angular velocity is high. Therefore, an increase in exposure time does not improve detection, as is the case in conventional celestial body photography.

By way of example, the telescopes (1 to 4) are reflecting telescopes with central obstruction comprising a primary mirror of large diameter (for example, astrographs with the sensor located in place of the secondary mirror), with the following features:
Focal length: 790 millimeters
Aperture: 356 millimeters
Obstruction: 0.44%
Resolution: 0.39 arc seconds
Sensor: 4000×4000 pixels with a width of 15 microns.

For an object with a diameter of 5 centimeters located at 1000 km, the parameters for a space object at a distance of 1000 km in altitude are given.

The time taken in a pixel is 6.5 ms for a pixel of 15 microns. Therefore, if a minimum streak length of 50 pixels is considered (for correct streak detection), the minimum exposure time would be 300 ms. The same calculation at 400 km gives an exposure time of 150 ms.

It is necessary to obtain at least three observations of the same object for a correct initial determination of the orbit with the following consequences:
It is not necessary to capture an entire portion of the sky, but just to capture the same object at different locations. This affords the possibility of capturing just a “slice” of the sky (the ring 20), the important thing being the detection of the object as it passes through the slice, as indicated in FIG. 2.

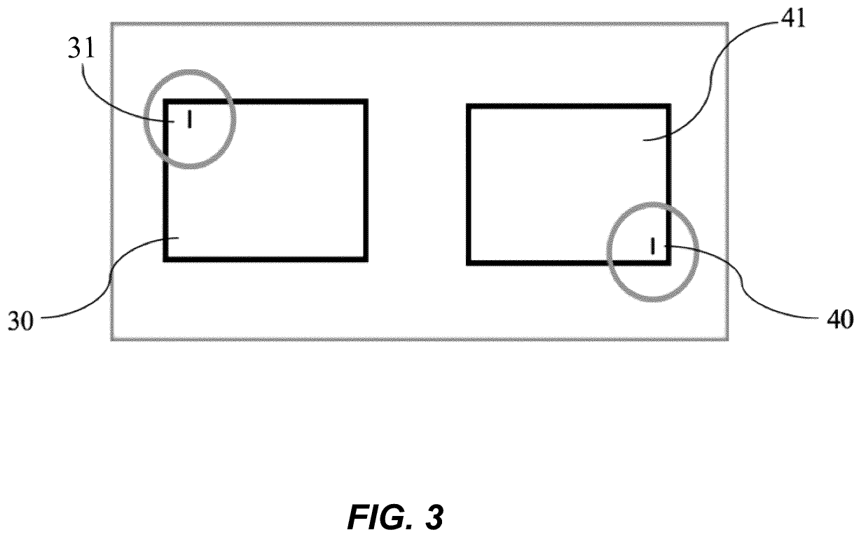

An object in orbit needs a few minutes to pass through the sky and a few seconds to cross the field of view of the telescope. Since one or two streaks (31, 41) in A and B are sufficient (FIGS. 2-3), continuous capture is not necessary. The important thing is to capture the same object twice, but this can be done with an interval of several seconds, in two images (30, 40), as shown schematically in FIGS. 2-3.

The rotation of the telescope uses the time interval between two images (30, 40) to capture the object at least twice in two different images.

Image Acquisition

With four telescopes per platform and to cover 90° in azimuth at an elevation angle of 66°, a field of view of 4° is possible. This represents 23 s between the first and the last images (4°/0.17) for objects at a distance of 2000 km. In lower orbits, this time interval could be shorter (13 s at 400 km).

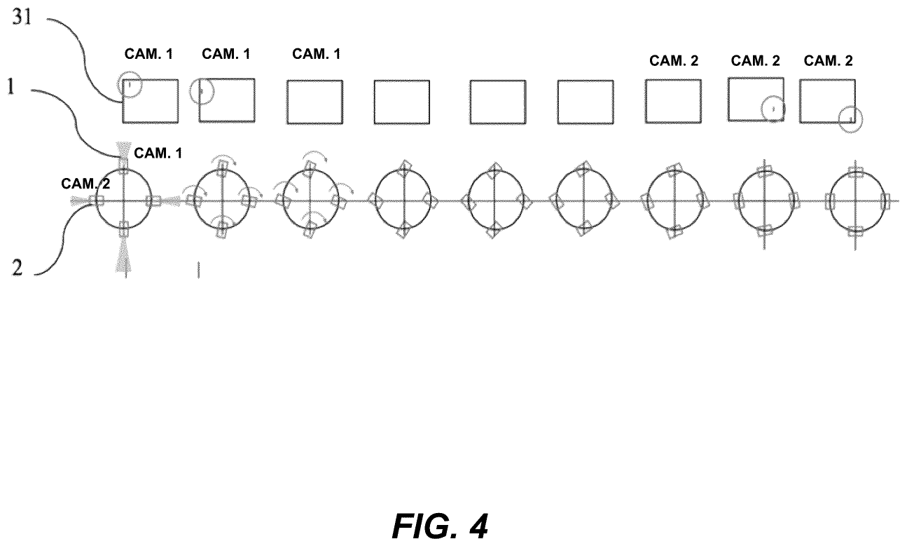

Therefore, if two telescopes (1, 2) are pointed at an angle of 90° outward, there are 23 s for the second camera (2) to take the position of the first camera (1). In this case, the left upper strip is captured by camera (1) and the lower right strip by camera (2), as indicated in FIG. 4. Thus, a single telescope is sufficient to cover 90°.

FIG. 4 schematically shows the situation in which four pivoting telescopes (1 to 4) are borne by a platform (10), each of them on an ALT-AZ mount, and each of them oriented at 90° from one another. Assuming that every second, the telescopes rotate by 11.25° (⅛ of 90°), then after 8 s, camera (2) can capture the streak that was captured by camera (1). In this example, if the time required for camera (2) to take the place of the camera (1) is less than 23 s, no object is left undetected, as illustrated in FIG. 4.

In this example, the sequence of movement, over one second, is as follows:
Rotate by 11.25°.
Stop.
Each camera is triggered for 300 ms.
Rotate by 11.25°
And so on . . . .

The platform (10) is optionally rotated in a jumping manner, having a speed profile similar to that of the hand of a jumping hour watch, with an angular step of 11.25° comprising alternating between moving quickly for 11.25°, being stationary for the image acquisition time, approximately 300 ms, moving by an angular step, and so on.

In addition, sidereal tracking is permanently on, to avoid telescope settling time when tracking starts.

Format of the Data Delivered by Each Telescope (1 to 4)

Each telescope is equipped with a sensor with N×M pixels, which provides digital images corresponding to the exposure time. Each image contains a background of fixed stars and traces in the form of streaks. These traces correspond to the movement of moving objects for the time between the beginning and the end of the acquisition of an image. The acquisition time is determined so that a streak covers a median value of 50 pixels.

Each image allows data to be extracted in the form of time-stamped coordinates with a resolution of at least one millisecond of the start and end of the streak.

These coordinates are determined by way of astrometry reduction using a catalog, for example, SKY2000 or TYCHO-2, or USND-SA (trade name), using matching processing. By way of example, some twenty stars are distinguished in a field of 3°×3° with an exposure time of 300 ms, forming patterns that allow them to be characterized using a matching algorithm for matching with the data from a star catalog.

All of the data thus collected for each of the images from each of the telescopes are centralized on a server to allow the reconstruction of the paths of the moving celestial objects whose traces have been recorded in different images in a time-stamped form. Estimating orbital paths for each object makes it possible to determine, for each of the objects, whether it belongs to the orbital path, in order to construct a catalog of orbital paths of the observed moving objects.

Exemplary Application

The table below gives the average rotational speed values of the space objects in the reference frame of the observation system, the time spent by the object in the field angle of the pixel of the camera and the exposure time required for a trace of 50 pixels. (RSO=resident space object).

TABLE 1

| RSO (route by overflown country) | | | |
|---|---|---|---|
| distance from Earth | Km | 250 | 500 |
| Calculation of local arc | | | |
| Local angle of the arc seen (over 180°) | ° | 30.47 | 42.45 |
| Time in the arc | S | 480 | 705 |
| Local angular velocity (over 180°) | °/s | 0.38 | 0.26 |
| Time in a pixel | S | 0.0023 | 0.0035 |
| Exposure time for a line of 50 pixels | Ms | 115 | 175 |
| Time in a field of view of 4° | S | 10.5 | 16.4 |

In the example at an altitude of 250 km, the average speed of rotation of the object in the reference frame of the station is 0.38°/s. It takes 10.5 s to traverse the entire field of observation of 4°. This is the maximum time for CAM2 to have the time to take an image of the same object as CAM1 while the object is in the field.

The table below shows the various speeds of rotation of the telescope according to the elevation angle of the observation ring.

TABLE 2
Speed of rotation according to elevation angle

| | Number of | Number of | Speed of rotation | |
|---|---|---|---|---|
| Elevation | fixed tele- | steps of 4° | for CM1 to replace | Number of |
| angle | scopes to | to cover | CAM2 (10.5 s) | seconds per |
| (°) | cover 360° | 90° | (°/s) | step of 4° |
| 36.8 | 72 | 18 | 6.9 | 0.58 |
| 66.4 | 36 | 9 | 3.4 | 1.17 |
| 78.45 | 18 | 5 | 1.7 | 2.33 |
| 84.25 | 9 | 2 | 0.9 | 4.67 |

The rotational speed values given are average values. Taking the example of an elevation angle of 66.4°, a step of 4° of rotation must be completed in 1.17 s. During this period of time, the mount of the telescope has to accelerate in rotation up to its nominal speed for a time calculated according to the capabilities of the motor, decelerate, and the camera has to be triggered for a minimum duration of 115 ms before the rotation process can begin again.

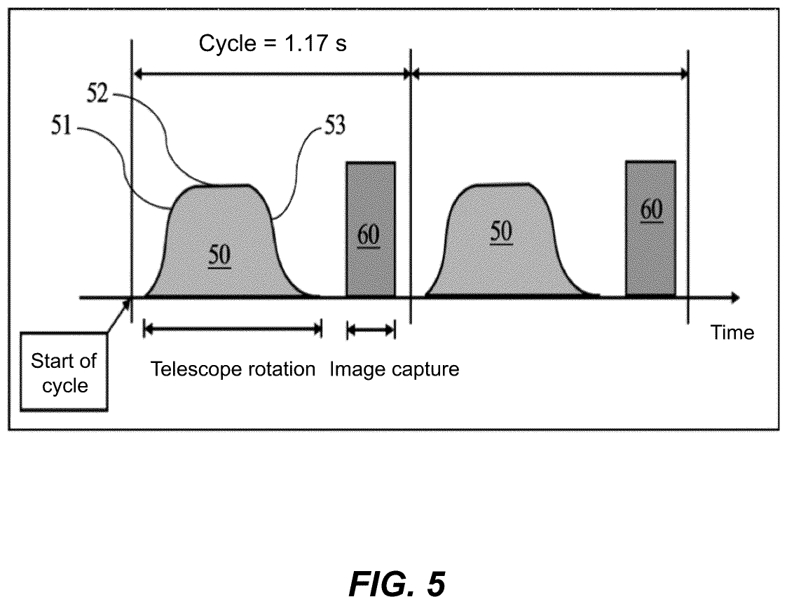

FIG. 5 illustrates the simplified kinematics of the operation. The rotation cycle lasts 1.17 seconds. During this cycle, the telescope alternates between an angular movement phase (50) and a stationary phase (60) for image capture. The movement phase (50) has a step (51) of accelerating until a flat rotational speed (52) is reached, then a step (53) of decelerating followed by a brief stabilization period, in principle without movement, before the image capture phase (60) in the stationary position.

Features of the Stations

The system comprises at least four stations, with locations meeting a number of criteria:

The sky should be of very high quality from an astronomical point of view, far from any light pollution. This means a magnitude of the sky (the same magnitude as defines the brightness of stars) that must be better than 19/°\hat{ }2.

The site should preferably be at altitude in order to experience as little atmospheric turbulence as possible.

The weather should make observation possible for at least 75% of the year.

There should preferably be the same number of stations in the Northern Hemisphere as in the Southern Hemisphere, so as to obtain a good distribution of measurements in order to improve the quality of the calculated orbits.

The locations of the stations should allow as complete a view of the geostationary arc as possible in order to ensure full monitoring thereof.

The number and locations of the stations depend on the possibility of continuous acquisition depending on how night cover moves.

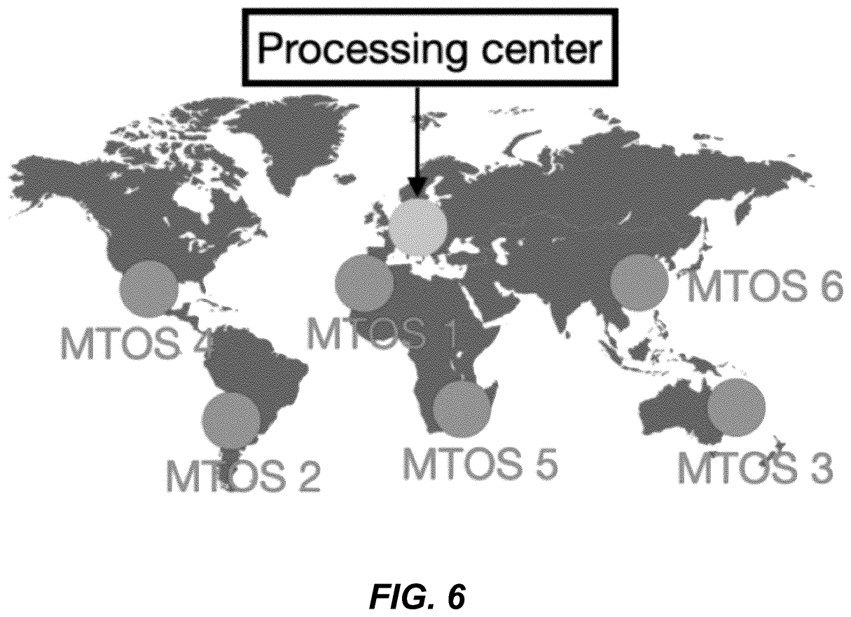

FIG. 6 shows exemplary locations of the stations for an array of six stations (MTOSs), each comprising four rotating telescopes. Possible locations that meet these criteria are Morocco, the Canary Islands, Chile, Australia, Namibia, New Mexico and Japan.

To measure the performance of the stations, a geometric and photonic simulator was used. This makes it possible to simulate the movements of a population of 1,000,000 objects of more than 1 cm around the world and to highlight the following:

The objects passing through the observation rings of each station.

The detectability of the objects by taking as reference a signal-to-noise ratio of 5 at the end of the acquisition chain for the digital sensor.

Depending on the characteristics of the telescopes and of the cameras selected, together with the locations of the stations, it is possible to estimate that the stations will allow the creation of a catalog of several tens of thousands of space objects in Earth orbit, all orbits combined.

Processing of the data.

The astrophotography image captures of space objects are part of an entire processing chain that makes it possible to determine the orbital paths of detected objects. These paths are then propagated: this operation involves determining the positions of the object in the future (about ten days). This makes it possible to calculate convergences between the most critical objects and to very precisely calculate the parameters of the probable collision (the date and time of collision, distance between the objects, probability of collision, spatial distribution of this probability).

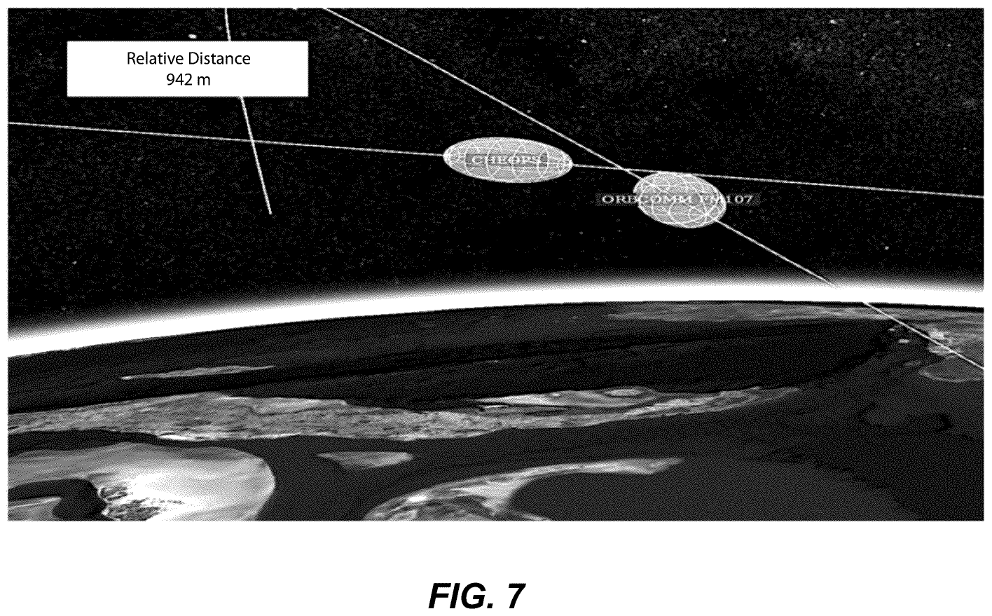

FIG. 7 is an illustration of a predicted collision and the highlighting, using ellipsoids, of positional uncertainties, allowing probabilities of collision to be established.

Processing of the Data

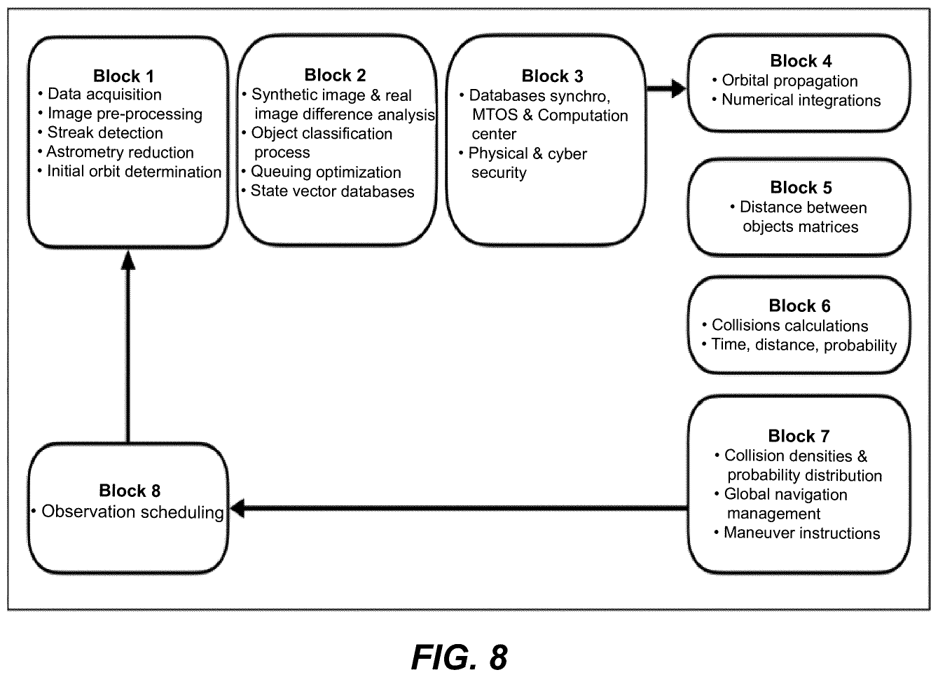

FIG. 8 schematically shows the functional architecture. The blocks operate in conjunction with one another, forming a coherent loop of calculation entities, where:
Block 1 relates to the local processing operations, in a station, for data acquisition, image preprocessing, path detection, astronomical calculations and determining the initial orbit.
Block 2 relates to the processing operations for detecting the differences between real images and synthetic images and analyzing the differences, classifying objects, optimizing queuing and calculating state vector databases.
Block 3 relates to the synchronization of local databases and the centralization of computations and to cybersecurity.
Block 4 performs orbital projections and numerical integrations.
Block 5 relates to the calculation of distances between objects and the construction of a distance matrix.
Block 6 relates to the calculation of risks, probabilities, distances and collision times.
Block 7 relates to the probabilistic calculation of risks and collision densities and to the calculation of navigation data, avoidance and maneuver instructions.
Block 8 relates to the scheduling of processing operations according to observational priorities.

Block 1 relates to the processing of the data coming from the camera systems and the telescopes, for each of the local stations. The processing operations are carried out in dedicated local computing units. These processing operations comprise image enhancement, streak detection, astrometry reduction and initial orbit determination.

The algorithms used to detect streaks are known and can be improved by virtue of a supervised machine learning algorithm. The data stream is about 1 image/s, potentially for 24 systems of rotating telescopes on six MTOSs (multi-telescope observation stations). The typical image size is 32 Mbytes (monochromatic images, coded on 16 bits, images of 16 megapixels). No buffer memory is provided to decrease processing time, and streak detection makes it possible to eliminate images of no interest and thereby reduce the storage capacity required. It is important to note that the data output by this first processing block is text data of very small size. Indeed, for network speed reasons, it is not practical to transmit image data in remote locations and over large distances.

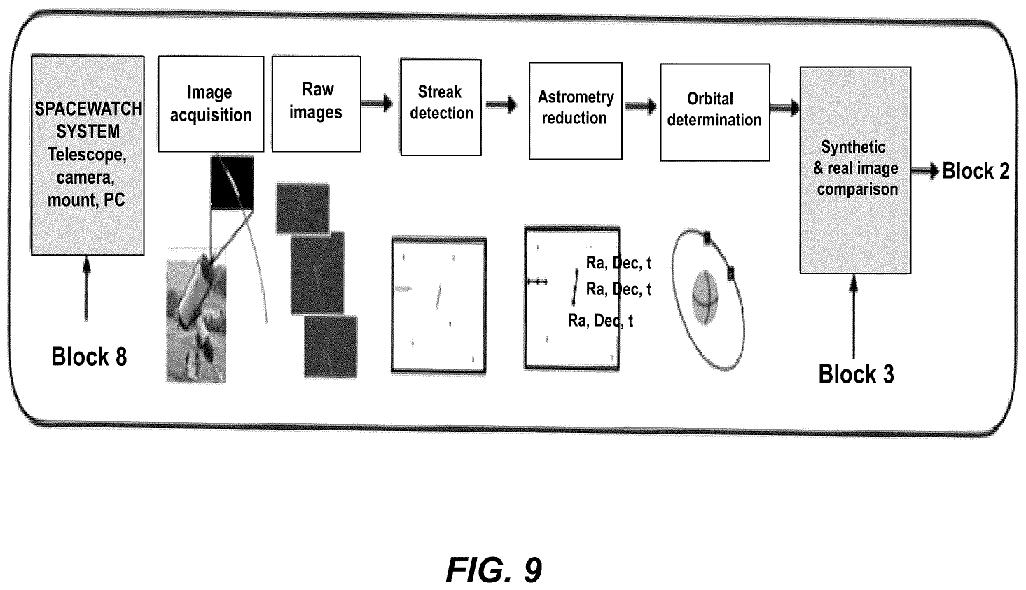

FIG. 9 shows the functional architecture of processing block 2 for the classification of objects. The function of this block 2 is to continuously update the catalog of the paths of space objects. The databases at local observation sites and those which are centralized must therefore be continuously synchronized.

In order to optimize the management of the queue of space objects, the following steps are implemented in this block 2:
Periodically calculating a theoretical image and comparing with the real image, for example, for each second acquisition.
Identifying and analyzing the differences between the theoretical image and the real image. All of the uncertainties related to the acquisition of the data appear at this stage: instrument error, atmospheric disturbances, space objects with variable illumination due to rotation or tumbling, satellite missing following a maneuver, satellite reappearing following a maneuver, new space object caused by a new launch, partial separation of an existing satellite or collision or explosion, new existing space object by virtue of better detection.

A very promising methodology for improving the performance of the queuing process remains that of increasing the correlation between objects that are detected at the position and time of different objects with the sets of images from all of the MTOSs. Ideally, the algorithm should learn to detect, with a certain level of confidence, the relationship between two objects separated in space and time. The result would be stored in a temporary list while waiting for another measurement to be carried out to confirm or reject if no correlation can be established after a given time.

Analyzing the differences between the synthetic images and the real images is not a simple task. Each path must be sent to a sub-category of the main database. The simplest case is that where the object is directly identified as corresponding to another in the database. This means that the position in the image remains within a tolerance range relative to the predicted position. A second layer of analysis must be provided for all other cases. If it is not carried out correctly, the number of objects in the queue increases spectacularly, to such an extent that the data can no longer be used at all. This part of the process classifies each object in the path data stream, with the smallest possible buffer in the queue, in near-real time. Artificial intelligence could be a solution to solve the problem and improve performance with time and experience. At the end of this block, all of the databases are identical across the different sites and include all of the state vectors for the object containing: three position values, three speed values and 36 values for the covariance of each object in terms of position and speed. Other elements can be added to the state vector depending on the calculations required (such as the area-to-mass ratio in the case of rotation or tumbling, or photometric characteristics of the object).

Block 3 relates to real-time synchronization between the different local databases of the MTOS sites and the computing center. The quality of the synthetic image depends on how complete the database is at a given moment, for each station, for each local system. Since MTOSs are remote from one other, the hardware of the network must be robust and reliable enough to achieve synchronization as quickly as possible. The network and the links must be physically and cyber-secure to ensure the best protection of sensitive data. It should be noted that the data traveling between the stations to achieve this synchronization are text data.

Block 4 relates to the calculation of state vectors for the database, and to the calculation of orbital propagations with numerical integration with a 15 s interval for a period of five days. Between 50,000 and 100,000 elementary calculations are required to numerically integrate a state vector with another, potentially for several thousand or hundreds of thousands of objects. For an object being entered into the database, on average 75,000 elementary calculations and a five-day propagation with 10 s integration interval, this represents 3,109 elementary calculations. On the basis of 200,000 measurements per day, the average frequency would be more than 20 incoming data values per second, which represents 6,1010 computations per second.

Block 5 relates to the calculation of distances between all of the objects for each integration time. As an underlying assumption, it can be considered that half of the objects cannot collide with one another. This would represent 100,000×100,000 matrices containing 2.5109 values, with a total of 8640 steps for five days, which is equivalent to more than 40,000,000 matrices to be updated.

Block 6 relates to the calculation of collisions using the differences between a time T+1 and a time T for a given pair of objects. The time and distance of collisions can be calculated with an associated probability, which gives another set of 40,000,000 matrices.

Block 7 relates to the intelligence layer, which processes collision densities and probabilities, overall navigation management and the automatic generation of instructions for satellite operators.

Block 8 uses the data from block 7, and optionally from block 6, to establish observational priorities and instrument scheduling resulting therefrom, in particular, when congestion becomes substantial or when special measurements have to be taken (laser telemetry, for example).

1. A system for detecting a path of moving celestial objects, the system comprising:
a plurality of telescopes each configured to rotate about a zenithal axis, each of the telescopes oriented with an elevation angle between 35 and 85°, each of the telescopes having a field of view between 2 and 6 degrees square and comprising a sensor of N×M pixels each of a width L for acquiring images; and
a central computer for recording time-stamped data corresponding to each of the images acquired by each of the sensors of each of the telescopes, wherein the data comprises, for each of the images, coordinates time-stamped with an accuracy of at least a millisecond of a start and of an end of each trace recorded during exposure time, coordinates of the start of each trace and the end of each trace being determined by way of astrometry reduction matching a pattern of fixed stars in each image with data from a star catalog, the central computer executing processing operations to estimate orbital paths for each moving object to determine, for each of the objects, whether or not the respective object belongs to an orbital path, and processing operations to record a catalog of orbital parameters of the moving objects.

2. The system of claim 1, wherein the telescopes are configured to rotate in a jumping manner.

3. The system of claim 1, wherein the telescopes are configured to rotate with a number of steps per second during rotation of the telescopes, the number of steps per second being determined by the relationship P×C=360. Cos E/N/T where:
V: speed V is a speed of rotation of an object relative to a position of the observation system at a given altitude and elevation angle;
C is a vertical and horizontal field of the camera;
N is the number of telescopes of the plurality;
T is a time lapsed while the object crosses the field C;
P is a number of steps taken to rotate by C horizontal degrees per second;
E is an object elevation angle relative to a horizontal plane at the observation system;
C=T×V.

4. The system of claim 1, wherein the system the plurality of telescopes comprises four telescopes each separated by 90°.

5. The system of claim 1, further comprising a platform, wherein the plurality of telescopes comprises four telescopes supported by the platform, axes of observation of the four telescopes being separated by 90°.

6. The system of claim 5, wherein the platform is configured to rotate in a jumping manner with steps of 11.25°.
